(19) United States
(12) Patent Application Publication
(10) Pub. No.: US 2009/0313973 A1
(43) Pub. Date: Dec. 24, 2009

(54) PROCEDURE FOR OPERATING A REAGENT METERING DEVICE AND DEVICE FOR IMPLEMENTING THE PROCEDURE

(75) Inventors: Damian Dyrbusch, Ludwigsburg (DE); Angelo Mazzon, Rutesheim (DE); Markus Boerner, Filderstadt-Bernhausen (DE)

Correspondence Address: MERCHANT & GOULD PC, P.O. BOX 2903, MINNEAPOLIS, MN, 55402-0903, US

(73) Assignee: Robert Bosch GmbH, Stuttgart (DE)

(21) Appl. No.: 12/484,371

(22) Filed: Jun. 15, 2009

(30) Foreign Application Priority Data
Jun. 18, 2008 (DE) 10 2008 002 508.9

(51) Int. Cl. F01N 3/18; G05D 16/00; F01N 11/00

(52) U.S. Cl. 60/286; 422/112; 60/299; 701/102

(57) ABSTRACT

A method of operating a reagent metering device, which contains a metering valve that is controlled by a metering signal, at which the reagent pressure actual value is detected in the reagent path between the metering valve and the injection valve, and at which a metering rate nominal value is specified, and a device for implementing the method. The method includes influencing of the metering signal (s_DV) with the aid of a measure for the detected reagent pressure actual value and with the aid of a stored relation between the measure for the reagent pressure actual value and a metering rate actual value. The method enables an operating of the reagent metering device with only one pressure sensor in the reagent path between the injection valve and the metering valve.

### TECHNICAL FIELD

The invention concerns a procedure for operating a reagent metering device, which is in particular provided in order to meter a reagent into the exhaust gas area of a combustion engine, and a device for implementing the procedure according to the category of the independent claims.

Subject matter of the present invention is also a control unit program as well as a control unit program product.

### Background

DE 10 2004 056 412 A1 describes a procedure and a device, at which a reagent that is under pressure is sprayed into the exhaust gas of a combustion engine upstream before an exhaust gas purification device, which contains a catalytic converter and/or a particle filter. The metering device for metering the reagent contains a security valve, a continuously adjustable metering valve, a reagent injection valve as well as a pressure sensor, which lies in the reagent path between the metering valve and the reagent injection valve. The pressure sensor enables a controlling of the reagent pressure by a comparison with at least one threshold value. By a specifically defined controlling of the security valve and also the metering valve different operating situations can be specified, which cause different reagent pressures. The threshold values are specified depending on the selected operating situation. When an error occurs in the metering device, which mirrors itself in a deviation of the reagent pressure from the expected pressure, an insufficient conversion rate of the exhaust gas purification device or a breakout of the reagent has to be expected. Therefore an error signal is provided at a deviation of the reagent pressure from the expected pressure, which requests the operator of the combustion engine to check the metering device.

DE 101 59 849 A1 also describes a procedure and a device, at which a reagent that is under pressure is sprayed into the exhaust gas of a combustion engine before a SCR-catalytic converter. Fuel is provided as reagent, which works as reagent in particular for the NO2-amount in the exhaust gas.

The reagent fuel, which means in particular hydrocarbons, can generally be provided for an exothermal reaction, which can for example be supported with a catalytically working surface. The developed thermal energy can be used for heating the exhaust gas or directly for heating a component of an exhaust gas purification device.

DE 10 2007 025 621 A1 describes a diagnosis procedure for a reagent metering device, which contains a continuously opening metering device and a reagent injection valve, at which the reagent pressure is detected in the reagent path between the metering valve and the reagent injection valve. The reagent pressure is controlled after a closing of the metering valve with regard to the occurrence of a pressure increase. If the pressure increase is not detected an error occurs, which can be displayed. The mentioned diagnosis procedure enables the detection of an occurring leakage in the reagent path as well as the detection of a jamming of the reagent injection valve in opened status.

The invention is based on the task to provide a procedure for operating a reagent metering device, which is in particular provided for metering a reagent into the exhaust gas area of a combustion engine, and a device for implementing the procedure, which enable a precise metering of the reagent with cost-efficient measures.

The task is solved by the characteristics that are stated in the independent claims.

### SUMMARY

The approach according to the invention for operating a reagent metering device is based on a reagent metering device, which contains a metering valve that is controlled by a metering signal and an injection valve, whereby the reagent pressure actual value is detected in the reagent path between the metering valve and the injection valve and whereby a metering rate nominal value is specified. The procedure according to the invention is thereby characterized, in that an influencing of the metering signal is undertaken with the aid of a measure for the detected reagent pressure actual value and with the aid of a stored relation between the measure for the detected reagent pressure actual value and a metering rate actual value.

The approach according to the invention provides the advantage that the reagent metering device can be operated with only one pressure sensor, which can be provided for implementing diagnosing tasks anyway. A detection of a reagent pressure actual value within the reagent metering device upstream before the metering valve can therefore be omitted. The approach according to the invention can therefore be realized cost-efficiently.

Advantageous improvements and embodiments of the approach according to the invention arise from the dependent claims.

One embodiment provides that a temporal average value of the reagent pressure actual value is determined as measure for the reagent pressure actual value and that the influencing of the metering signal takes place due to this average value.

Another embodiment provides that the metering signal is realized as impulse width modulated signal and that the determination of the temporal average value of the reagent pressure actual value takes only place during the operating time of the impulse width modulated signal. When creating an average value only the time duration is considered, during which a metering takes place. With this measure the influence of interfering signals, which may overlap the reagent pressure actual value during the impulse pauses of the impulse width modulated signal, are efficiently suppressed.

A further embodiment provides that the influencing of the metering signal is based on pressure parameters. The metering rate nominal value is then converted into an average reagent pressure nominal value with the aid of the stored relation between the measure for the reagent pressure actual value and the metering rate actual value. Alternatively it can be provided that the influencing of the metering signal takes place due to metering rate parameters. In that case the determined measure for the reagent pressure actual value is converted into a metering rate nominal value with the aid of the stored relation between the measure for the reagent pressure actual value and the metering rate actual value.

One embodiment provides that the influencing of the metering signal is provided within the scope of a pre-controlling as well as a regulation of the metering signal and that the regulating correcting variable of the regulator of the pre-control variable of the pre-control is overlapped.

According to the invention the device for implementing the procedure provides at first a hardware realized low-pass filter for creating the average value of the reagent pressure actual value. The low-pass filter averages at least such pressure oscillations, which can originate by the injection vale, which is realized in the simplest case as a spring loaded valve, which provides a specific opening pressure, whereby the pressure oscillations occur due to a fast sequence of opening processes. The creation of the average value by the low-pass filter enables the use of cost-efficient downstream components, which have to provide a comparatively low sampling rate for electrical input signals, which may be located for example at 1 ms.

According to the invention the device for implementing the procedure concerns furthermore a customized control unit, which contains measures for implementing the procedure.

The control unit contains in particular a software realized average value determination for determining the average value of the reagent pressure actual value as a measure for the reagent pressure actual value as well as a functional relation between the measure for the reagent pressure actual value and the corresponding metering rate actual value.

The control unit preferably contains at least one electric storage, in which the steps of the procedure are stored as a control unit program.

The control unit program according to the invention provides, that all steps of the diagnosis procedure according to the invention are implemented if it runs in a control unit.

The control unit program product according to the invention with a program code that is stored on a machine-readable medium carries out the diagnosis procedure according to the invention if the program runs in a control unit.

Further advantageous improvements and configurations of the approach according to the invention arise from further dependant claims. Embodiments of the invention are illustrated in the drawing and further explained in the following description.

### BRIEF DESCRIPTION OF THE DRAWING

FIG. 1 shows a technical environment, in which a procedure for operating a reagent metering device is running according to the invention.

### DETAILED DESCRIPTION

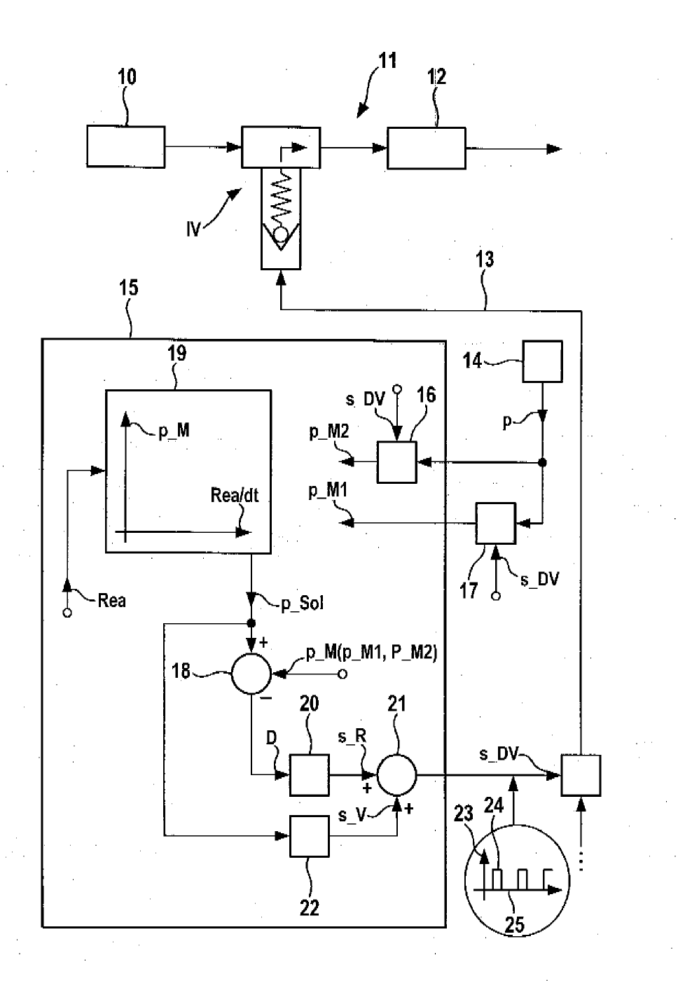

The FIG. 1 shows a combustion engine 10, in whose exhaust gas area 11 a reagent injection valve IV is arranged and an exhaust gas purification device 12 downstream after the reagent injection valve IV. The reagent injection valve IV is connected with a metering valve DV over a reagent path 13, at which a pressure sensor 14 is arranged.

The pressure sensor 14 provides an average value determination 16 as well as a low-pass filter 17 that are in a control unit 15 with the reagent pressure actual value p that occurs in the reagent path 13. The low-pass filter 17 provides a reagent pressure average value p_M1. The average value determination 16 provides a reagent pressure average value p_M2. The reagent pressure average value p_M1 or the reagent pressure average value p_M2 are subtracted as a measure in a first adder 18 from a reagent pressure nominal value p_Sol.

The reagent pressure nominal value p_Sol or at least a measure for the reagent pressure nominal value p_Sol is provided by a functional relation 19 with the aid of a stored characteristic line between a metering rate actual value Rea/dt and a measure p_M for the reagent actual pressure p depending on a default metering rate nominal value Rea/dt_Sol.

The difference D that is provided by the first adder 18 is provided to a regulator 20, which provides a regulating correcting variable s_R to a second adder 21, which adds the regulating correcting variable s_R to a pre-control variable s_V, which determines a pre-control 21 depending on the reagent pressure nominal value p_Sol. The second adder 21 provides a metering signal s_DV, which is provided to the metering valve DV as well as the average value determination 17. The metering signal s_DV is realized as impulse width modulated signal 23, which provides operating times 24 and down times 25 in a periodical sequence.

According to the invention the procedure works as follows:

The exhaust gas of the combustion engine 10 contains undesired components as for example nitrous gases and particle. The exhaust gas purification device 12 has the task to reduce the undesired components as much as possible. The exhaust gas purification device 12 contains for example at least one catalytic converter, for example an oxidization catalytic converter and/or a NOx-storage catalytic converter and/or a SCR-catalytic converter as well as a particle filter if necessary.

The exhaust gas device 12 can require a minimum temperature, which has to be exceeded for accomplishing the exhaust gas purification function. A reaction takes for example optimally place at a catalytically working surface within a certain temperature window. Furthermore a minimum temperature might be necessary to be able to carry out a regeneration of at least one component of the exhaust gas purification device 12. A particle filter requires for example a starting temperature for starting the particle burn-off, which can be located between 450-650 ° C. A NOx-storage catalytic converter requires an increased temperature during the regeneration. In particular for the regeneration of sulfur poisoning very high temperatures up to 800° C. are required.

For a temperature increase of the exhaust gas the reagent can be given into the exhaust gas area 11, which reacts on a catalytically working surface exothermally with the oxygen that is contained in the exhaust gas. The reagent can also be in added in order to enable a chemical reaction in the exhaust gas area 11.

The reagent can for example be fuel, so that a separate carrying along of a reagent, for example in a motor vehicle can be waived.

The metering rate, with which the reagent should be metered into the exhaust gas area 11 is specified by the metering rate nominal value Rea/dt_Sol, which is for example determined depending on the required temperature increase of the exhaust gas purification device 12. It is assumed in the illustrated embodiment that the influencing of the metering signals s_DV has to be carried out on the basis of pressure variables. Therefore the metering rate nominal value Rea/dt_Sol is converted in the functional relation 19, which contains the relation between the measure p_M for the reagent pressure actual value p and the metering rate actual value Rea/dt in the form of a characteristic line, into the reagent pressure nominal value p_Sol, which is provided to the first adder 18 and the pre-control 22.

From the reagent pressure nominal value p_Sol the pre-control 22 determines the pre-control variable s_V, which is taken over the second adder 21 and which creates the basis of the metering signal s_DV. If only a controlled operation shall be provided the adder 21 can be waived, so that the pre-control variable S_V is identical to the metering signal s_DV.

But preferably the regulator 20 is provided, in order to ensure a high accuracy of the metering. The regulator 20, preferably a PI-regulator is provided with the difference D that has been determined by the first adder 18 between the reagent pressure nominal p_Sol and the measure p_M or the detected reagent actual pressure p as input variable. The measure p_M or the detected reagent actual pressure p can be the reagent pressure average value p_M1 or the reagent pressure average value p_M2. The regulator 20 provides the regulating correcting variable s_R, which is given to the second adder 21, which adds the regulating correcting variable s_R to the pre-control variable s_V.

The metering signal s_DV is preferably an impulse width modulated signal 23, which switches the metering valve DV in a fast sequence. The minimal impulse duration 24 is for example 100 ms, while the impulse pause 25 can be located in the seconds area. During the metering operation a pressure oscillation can occur in the reagent path 12, which is caused by the reagent injection valve IV, which is realized according to an advantageous embodiment as spring loaded valve with a certain opening pressure. The frequency of the pressure oscillation can be located in the kilohertz area, for example at 1 kHz.

Under the condition that the components of the control unit 15 provide no relevant limitation at the sampling of the signal that mirrors the reagent pressure actual value p and that is provided by the pressure sensor 14, preferably only the software realized average value determination 16 is provided if necessary, which provides the reagent pressure average value p_M2 as a measure for the reagent pressure actual value p. according to an improvement it is provided that the average value creation is only carried out during the operating time 24 of the impulse width modulated signal. Thereby possibly occurring disturbing signals during the impulse pause 25 of the impulse width modulated signal 23 can be completely suppressed if necessary. Therefore the average value determination 16 is provided with the metering signal s_DV.

According to a particularly advantageous configuration the hardware realized low-pass filter 17 is provided, which is independent of the further components of the control unit 15. Therefore it is preferably a separate assembly group. The low-pass filter 17 provides the reagent pressure average value p_M 1. The low-pass filter 17 is realized in such a way that the impulse duration 24 of the impulse width modulated signal 23 can basically pass the low-pass filter 16, but also that the high-frequency pressure oscillations are suppressed. The separate low-pass filter 16 enables the use of further electronic components, which provide comparatively only a low sampling rate of for example 1 ms, but whereby the control unit 15 can be realized comparatively inexpensive. If necessary the low-pass filter 17 is provided with the impulse width modulated metering signal s_DV, so that the average value creation can be fixed to the operating time 24 of the impulse width modulated signal 23.

According to an embodiment that is not shown in the figure it can be provided, that the reagent pressure average value p_M1 that is provided by the low-pass filter 17 is provided to the average value determination 16, which is additionally provided in order to achieve a signal filtering that is more targeted than with the low-pass filter 17 that can be realized comparatively simply, for example as R-C-combination.

Instead of the shown realization of the procedure according to the embodiment on the basis of pressure variables p_M, p_M1, p_M2, p_Sol likewise a realization is possible on the basis of metering rate variables. In that case the metering rate nominal value Rea/dt_Sol is directly provided to the first adder 18 and the measure p_M for the reagent pressure actual value p is converted with the aid of the functional relation 19 into a metering rate actual value.

1. A method of operating a reagent metering device comprising a metering valve actuated by a metering signal and an injection valve, the method comprising:
detecting a reagent pressure actual value in a reagent path between the metering valve and the injection valve;
specifying a metering rate nominal value; and
influencing the metering signal with a measure for the detected reagent pressure actual value and with a stored relation between the measure for the reagent pressure actual value and a metering rate actual value.

2. The method of claim 1, further comprising evaluating a temporal average value of the reagent pressure actual value as the measure for the detected reagent pressure actual value.

3. The method of claim 2, further comprising defining the metering signal as an impulse width modulated signal, wherein the evaluation of the reagent pressure average value occurs only during an operating time of the impulse width modulated signal.

4. The method of claim 1, further comprising converting the metering rate nominal value into a reagent pressure nominal value with the stored relation between the measure for the reagent pressure actual value and the metering rate actual value, wherein the reagent pressure nominal value is used to influence the metering signal.

5. The method of claim 2, further comprising influencing of the metering signal based on reagent rate variables, wherein the measure for the reagent pressure actual value is converted into a metering rate nominal value with the stored relation between the measure for the reagent pressure actual value and the metering rate actual value.

6. The method of claim 1, further comprising creating the metering signal from a regulating correcting variable and a pre-control variable.

7. A control unit configured to implement method of operating a reagent metering device comprising a metering valve actuated by a metering signal and an injection valve, including detecting a reagent pressure actual value in a reagent path between the metering valve and the injection valve and specifying a metering rate nominal value, the device comprising:
a stored relation between the measure for the reagent pressure actual value and a metering rate actual value, wherein the metering signal is influenced with a measure for the detected reagent pressure actual value and with the stored relation between the measure for the reagent pressure actual value and a metering rate actual value.

8. The control unit of claim 8, further comprising an average value determination for an arithmetic determination of a reagent pressure average value.

9. The device of claim 8, wherein the reagent metering device injects a reagent into an exhaust gas area of a combustion engine.

10. A control unit program that executes all steps of a method, if run on a control unit, of operating a reagent metering device comprising a metering valve actuated by a metering signal and an injection valve, the method comprising: detecting a reagent pressure actual value in a reagent path between the metering valve and the injection valve; specifying a metering rate nominal value; and influencing the metering signal with a measure for the detected reagent pressure actual value and with a stored relation between the measure for the reagent pressure actual value and a metering rate actual value.

11. The control unit of claim 8, wherein a low-pass filter configured in hardware provides a reagent pressure average value from the reagent pressure actual value to the control unit.
